(19) United States
(12) Patent Application Publication
(10) Pub. No.: US 2012/0066358 A1
(43) Pub. Date: Mar. 15, 2012

(54) METHOD OF GENERATING A NETWORK MODEL

(76) Inventor: Martin Hobbs, Bath (GB)

(21) Appl. No.: 13/321,441

(22) PCT Filed: May 18, 2010
(86) PCT No.: PCT/GB10/00987

§ 371 Date: Nov. 18, 2011

(30) Foreign Application Priority Data
May 18, 2009 (GB) 0908411.2

(51) Int. Cl. G06F 15/177

(52) U.S. Cl. 709/222

(57) ABSTRACT

A method of configuring a network model of a network is disclosed that may include a plurality of interconnected network elements. An embodiment of the method may include: a) accessing a plurality of predefined network element models, with each element model defining a network element and including element configuration data relating to the element; b)receiving selection data defining a selection of the plurality of network element models; c) receiving element connection data defining interconnections between selected network element models; and d) automatically configuring network model data for the network model in dependence upon the received selection and connection data. Also disclosed are: a) a network model configured according to the disclosed method; b) a network configured according to the method; c) a system for configuring a network model; and d)a method of analyzing a network that may include accessing the network model.

### BACKGROUND TO THE INVENTION

The present invention relates to a method of generating a network model.

Managed networks exist everywhere, including telecommunications networks, utilities pipelines, television and radio broadcast networks, to name just a few. It is essential that such networks are monitored to detect equipment failure and many conventional networks include self-monitoring systems which vary widely in their level of complexity depending on the type and complexity of the network involved.

Irrespective of the level of complexity of the network, a managed network will conventionally include centralised or regionalised management capabilities to allow network operators to monitor the status and performance and re-configure the network in response to changing operational needs or failures.

This is acceptable if the managed network can be monitored and maintained by a reasonable number of experienced network operations personnel. Under these circumstances, human operators are responsible for correlating the streams of state change events and performance information received from individual network components and, based on their experience, of operating that network under a range of operational and fault conditions, adjusting the operational parameters to provide the required level of service to their customers.

A major problem arises however when the size and complexity of the network exceeds the capability of the operators to correlate the streams of information received from it. In this situation, network operations often turn to event correlation systems in an attempt to automate some of the analysis workload and speed up fault resolution times.

Event correlation systems typically break down into two types:
Out-of-the-box solution, providing a range of standardised network and equipment models and problem analyses for commonly available technologies e.g. IP Communications Networks.
Rule-based, low-level correlation toolkits, based on Inference Engine technology, suitable for constructing localised stream-based correlations.

Each of these types of system has their own advantages and disadvantages. The former are characterised by rapid deployment but a significant cost, targeted at specific technologies where the investment in developing the correlation solution is justified by the number of similar installations that may benefit from the technology. The major problem however, is that the manufacturer determines the range of correlations available and developing user-defined correlations is often technically beyond the ability of the user. Users are also reliant on the supplier providing a continual stream of equipment models as new versions or types are introduced into the market place.

Users of low-level toolkit based solutions benefit from the ability to develop and deploy stream-based correlations from point sources in the network e.g. for event de-duplication or counting over time. Unfortunately, more complex correlations such as those requiring knowledge of the implicit relationships between network components and how their state change over a period of time, result in an explosion in complexity. Typically, the size of the rule based quickly becomes unmanageable and often requires additional, expensive software development to achieve the desired result.

There is therefore a need for a method of network mapping and monitoring that allows the creation and management of both simple and complex networks which can be updated/altered easily without the requirement for highly skilled and experienced network operations personnel.

### SUMMARY OF THE INVENTION

The present invention seeks to address the problems of the prior art.

Accordingly, a first aspect of the present invention provides a method of configuring a network model of a network which includes a plurality of interconnected network elements, the method comprising the steps of
a. accessing a plurality of predefined network element models, each element model defining a network element and including element configuration data relating to the element;
b. receiving selection data defining a selection of the plurality of network element models;
c. receiving element connection data defining interconnections between selected network element models; and
d. automatically configuring the network model data for the network model in dependence upon the received selection and connection data.

The present invention involves the modelling of a network. State and performance change events in an implemented network and observed by a network management system can then be visualised using the network model to understand and identify any problems within the network. Steps can then be taken to investigate and resolve the root of any identified problems. In addition, the network model may be used to determine the effects on the overall network of any modelled events and/or state changes.

The provision of predefined network element models each defining a network element and including element configuration data avoids the requirement for complex network configuration coding operations to take place each time an element incorporation event takes place. Instead, the network element model includes element configuration data, and once a network element model has been selected and connection data received relating to the desired location of the network element within the network relative to the other network elements, the network may be automatically configured to integrate the element within the network model. This is possible as the element configuration data and connection data required for the automatic configuration of the network model has already been defined.

In one embodiment, the method further comprises the steps of defining and storing a plurality of predefined network element models, each element model defining a network element and including element configuration data relating to the element, prior to the step of accessing the plurality of predefined network element models.

The network element model defines a network element and includes element configuration data relating to the element. The configuration data may include set-up parameters for the network element. Such set-up parameters may include, but are not limited to: unique identifier, instance (friendly) name, type (class), sub-type, and the like.

Alternatively, or in addition, the configuration data may include operational parameters for the network element. Such operational parameters may include, but are not limited to: service state (for example, In-Service, Commissioning), Latitude, Longitude, and the like.

Alternatively, or in addition, the configuration data may include connection parameters for the network element. Such connection parameters may include, but are not limited to: Unique identifier and Type (class) of Parent, Relative (like Uncle) and Associate (like Friend) Network Elements, and the like.

Each network element may comprise a single network component or may define a plurality of interrelated network components. For example, an element network model may define a network component such as an input node, pipeline hub, CPU or the like. Alternatively, a network element may comprise a computer network, or pipeline network or the like. It will be appreciated that where an element network model defines a plurality of interrelated network elements, the element network model includes configuration data relating to each of the network components and their inter-relationship with one another.

A second aspect of the present invention provides a method of analysing a network, the method using a network model configured according to a method of a first aspect of the present invention.

The method may further comprise adjusting network parameters and updating the network configuration data in dependence upon the adjusted network parameters. Automatic updating of the network configuration data allows selected network parameters to be adjusted and the overall effect of such adjustments on the network model observed. For example, if an existing network element is to be replaced by a newer equivalent network element, adjusting of the network model to swap the newer network element from the previous network element and updating of the network element will allow any adverse effects of the change in the network to be observed (and potential solutions to overcome any observed adverse effects implemented and tested within the network model environment) before the actual implementation of the newer network element within the actual network itself.

In one embodiment, the adjusted network parameters include element configuration data. Alternatively, or in addition, the adjusted network parameters may include element connection data.

A third aspect of the present invention provides a method of analysing a network comprising;
accessing a network model of the network, the network model data being configured using a method as provided by a first aspect of the present invention;
receiving input data relating to the network;
updating the network model data in dependence upon the received input data;
comparing the network model data with the updated network model data and identifying variations between the network model data and updated network model data.

In one embodiment, the method further comprises the step of defining and storing network model data of the network prior to accessing the network model data.

In a further embodiment, the method further comprises identifying the or each altered network parameter responsible at least in part for the variation between the network model data and updated network model data.

In this way, changes to the network model may be made, compared with the original network model, and the observed variations attributed to the changes made, thus providing a useful means of analysing network adjustments and associated effects.

A further aspect of the present invention provides a network model configured using a method in accordance with a preceding aspect of the present invention.

In one embodiment, each network element model includes set up parameters for the network element concerned.

Each network element model may include operational parameters for the network element concerned.

Alternatively, or in addition, each network element model may include connection parameters for the network element concerned.

Another aspect of the present invention provides a method of managing a network using a network model configured using a method of the first aspect of the present invention, the network model providing the configuration information necessary for the network, the method including determining differences between the network and the network model, and reconfiguring the network in dependence upon those differences.

Such management of a network can include rerouting of existing network connections in the case of routing faults, providing new network connections, or providing an entirely new network.

A further aspect of the present invention provides a network configured using a method in accordance with a preceding aspect of the present invention.

A further aspect of the present invention provides a system for configuring a network model of a network which includes a plurality of interconnected network elements, the system comprising an element unit operable to store element data; and
an input unit operable to receive selection and connection data;
a configuration unit in communication with the element unit and the input unit, and operable to receive element data, selection data, and connection data, and to configure automatically a network model in dependence upon the received element selection and connection data.

### BRIEF DESCRIPTION OF THE DRAWINGS

An embodiment of the invention will now be described, by way of example only, and with reference to the accompanying drawings, in which:

FIG. 1 is a diagrammatical representation of a network;

FIG. 2 is a diagrammatical representation of an embodiment of a system in accordance with an aspect of the present application; and

FIG. 3 is a flowchart of an embodiment of a method of configuring a network model in accordance with an aspect of the present invention.

### DETAILED DESCRIPTION OF THE INVENTION

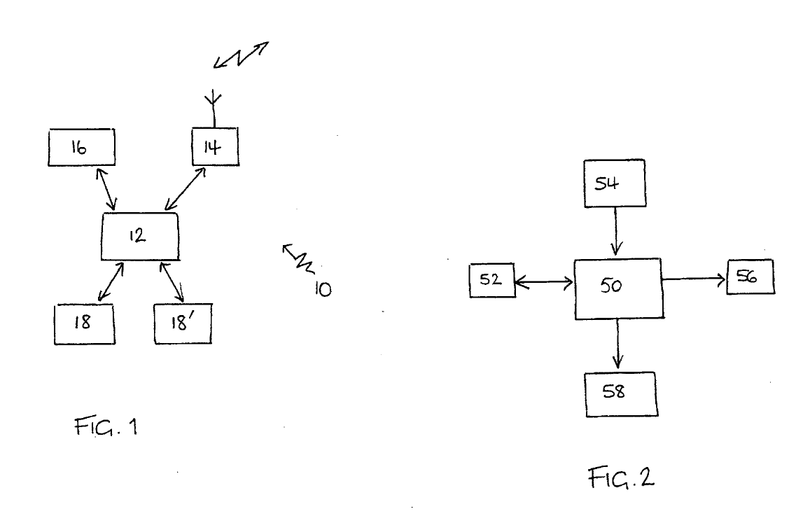

FIG. 1 embodies an example of a network 10, the network 10 comprising a server 12 (controller) in communication with several other components of the network 10, including a wireless hub 14, a printer 16, and PCs (personal computers) 18, 18′. All the component parts of the network 10 have their own specific set-up parameters and operational parameters and the communication links between respective components of the network 10 have specific connection parameters which are dependent upon many factors including, but not limited to, the type of connection being made, the respective components being connected, other component connections within the network 10 and the operational requirements of the network 10.

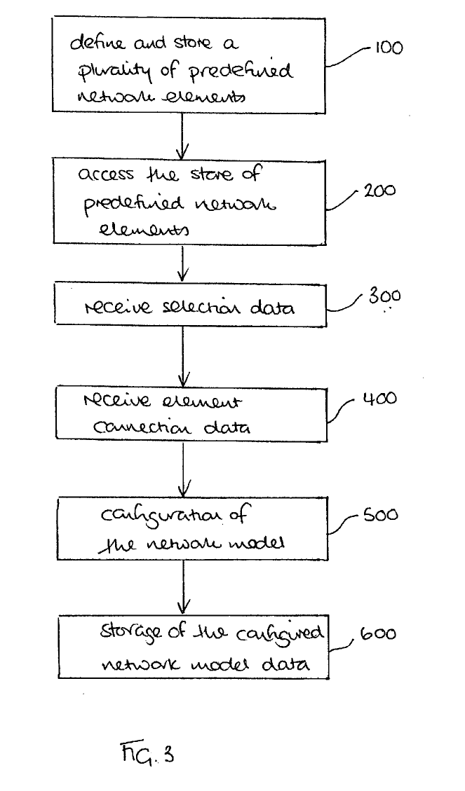

FIG. 2 shows the component parts of an embodiment of a system in accordance with an aspect of the present invention. Configuration unit 50 is in communication with element data storage unit 52, input unit 54, display unit 56 and configured network model data storage unit 58. User input at input unit 52 is transmitted to configuration unit 50. Element data storage unit 52 is operable to store and transmit element model data to configuration unit 50 on request from configuration unit 50 in dependence upon said user input at input unit 54. The received element unit data then processes the received element model data to configure a network model. Configuration unit 50 is operable to transmit the configured network model to display unit 56 for visualisation to a user and optionally, the configured network model data is transmitted to configured network model data storage unit 58 for storage and subsequent retrieval if desired.

Operation of the system of FIG. 2 will now be described with reference to the method embodying an aspect of the present invention as shown in FIG. 3.

The system comprises an element data storage unit 52 operable to store a plurality of network element models. A plurality of predefined network element models are prepared and stored at element data storage unit 52, each element model defining a network element and including element configuration data relating to the element.

A first step is to prepare and store such a plurality of network element models for storage at storage unit 52 (store 100). These network element models comprise those network elements desired for use in the configuration of the network model. For example, if the network model relates to a computer network, then the element models are likely to include PCs (personal computers) elements, printer elements, server elements, interne hub elements and the like. However, if the network model relates to a pipeline network, then the element models are likely to include pipeline elements, pipeline joint elements, sensor elements, alarm elements, and the like. Each model element will include element configuration data specific to that element, the element configuration data including, but not restricted to, set-up parameters, operational parameters and connection parameters.

Once a plurality of network element models for a network model have been prepared and stored as described above, the next step is to access selected element models stored at storage unit 52 (step 200).

Element data storage unit 52 is in communication with a configuration unit 50 which is operable to configure network model data in dependence upon received inputs. On receipt of input data provided from a user at input unit 54, input unit 54 is operable to transmit the input data to the configuration unit 52 (step 300).

On receipt of the input data from input unit 54, configuration unit 50 is operable to transmit a request for element model data from element model data storage unit 52.

On receipt of the request from configuration unit 50, element model data storage unit 52 is operable to select the requested element model and transmit said element model to configuration unit 50. Each predefined element model defines a predefined network element and includes element configuration data relating to the element.

On receipt of the predefined element model from the element model data storage unit 52, the configuration unit 50 is operable to supply the element model to the display unit 56 for visualisation to a user.

The user may then provide further input at input unit 54 to stimulate a further request by configuration unit 50 to element model data storage unit 52 for a further element model, the user input at input unit 54 defining both the element model to be selected and the relative placement of the element model in the network model relative to previously selected element models (step 400).

Configuration unit 50 is then operable on receipt of the subsequent element model and relative placement data to configure the network by automatically configuring connections between adjacent element models using the configuration data of each respective element model and the relative placement information provided by the user at input unit 54 (step 500). Once the network model has been configured to incorporate the selected element model, the configuration unit 50 is operable to transmit the configured network model data to display unit 56 for visualisation by a user.

The configured network model data storage unit 58 is operable to receive and store the configured network model data (step 600). The configured network model data may then be accessed at a future time on demand.

In one embodiment, the user input is provided by selecting a predefined element model from a presented plurality of such predefined element models, each predefined element model being presented as a unique icon or distinct visual graphic representation. A user would simply select the icon representing the desired element model by moving a cursor over the icon, clicking on the icon and then dragging the icon from an area of a display and dropping it at a desired location within a network model area of a display. A second element model would be selected in a similar manner, dragged to the network model area of the display and dropped at position within the network model area of the display relative to the previously selected element model icons so as to define the respective relationship between the selected element models within the network.

A typical network model is constructed in a multi-layered fashion to emulate the conceptual models employed in practice. The lowest layer is comprised of elements that represent physical components of the actual network e.g. computers, interface cards, cables, microwave links, pipelines, pumps. The intermediate layer is built from logical elements that rely on the physical layer for their existence and in turn provide the basic components for building end user services e.g. telephone call data multiplexed in timeslots on a physical transmission link. The highest layer provides a representation of services delivered to users of the network and is constructed from service components provided by the logical layer e.g. an IPTV service relies on content delivery from playout sources delivered over logical channels.

The layers in the network model do not exist in isolation. The ability of a component in an intermediate layer to offer its function depends in all or part on the ability of components in the lower layer to deliver the necessary capabilities. Hence, a failure in a lower layer component may have an adverse effect on the ability of a higher level component to deliver its function. Using a method embodying the present invention, it is possible to create a model of a network which model includes information regarding the interaction of the several logical layers of the network. As such, the model can be used to determine the effect of faults or changes in one layer on the other layers of the network. For example, a switching layer error may result in routing layer and application layer errors, whilst a physical layer error may cause follow on errors in the switching layer. A model developed according to the method of the present invention allows a modeler to predict the effect of errors at any given layer of the network, without the need for recalculation of the model. Such failure mode modeling is simply not possible using manual or previously considered techniques, since it is not possible to interact with the model.

A network model developed in accordance with one embodiment of the present invention allows the automatic and rapid propagation of errors through the model, which enables the prediction of failure modes for the whole or a part of the network, rather than just for the error generating part of the network itself. Existing techniques do not allow or enable such error propagation to be predicted, and so active network management is now made possible by the ability to configure a network model that is changeable in real time.

Such interactivity of the network model allows management of a network, including reconfiguration of network links and devices, in large and complex networks. This management has not been possible previously.

Another method embodying an aspect of the present invention includes using a network model generated in another embodiment of the present invention to allow configuration and reconfiguration of a new or an existing physical network. Such configuration of a network can, for example, include rerouting of existing network connections in the case of routing faults, and providing new network connections.

For example, in a simple computer network, an icon representing a PC may be dragged and dropped into the network model area of the display, an icon representing a printer element may be dragged and dropped into the network model area of the display and an icon representing a direct two way connection may be dragged and dropped into the network model area of the display and aligned such that the three icons are adjacent with the connection icon located directly between the PC icon and the printer icon. The configuration unit 50 would then automatically configure the network model in dependence upon the element configuration data defined by each element model i.e. the set-up parameters and/or operational parameters and/or connection parameters, coupled with the received element connection data provided by the selected relative placement of the element model icons within the network model area of the display.

This process allows the configuration of a network model of whatever selected complexity by a user without the need for extensive skill in network modelling. Instead, the process may be carried out using visual icons with configuration of the network model carried out automatically in dependence upon the configuration data defined by the selected network element models and the connection data provided by the relative placement of the element model icons relative to one another by the use in the visual display.

Although aspects of the invention have been described with reference to the embodiment shown in the accompanying drawings, it is to be understood that the invention is not limited to the precise embodiment shown and that various changes and modifications may be effected without further inventive skill and effort.

1. A method of configuring a network model of a network which includes a plurality of interconnected network elements comprising:
access a plurality of predefined network element models, each element model defining a network element and including element configuration data relating to the element;
receiving selection data defining a selection of the plurality of network element models;
receiving element connection data defining interconnections between selected network element models; and
automatically configuring network model data for the network model in dependence upon the received selection and connection data.

2. The method according to claim 1, further comprising of defining and storing a plurality of predefined network element models, each element model defining a network element and including element configuration data relating to the element, prior to the step of accessing the plurality of predefined network element models.

3. The method according to claim 1, wherein each network element model includes set up parameters for the network element concerned.

4. The method according to claim 1, wherein each network element model includes operational parameters for the network element concerned.

5. The method according to claim 1, wherein each network element model includes connection parameters for the network element concerned.

6. The method of analyzing a network, the method using a network model configured according to the method of claim 1.

7. The method according to claim 6, further comprising:
adjusting network parameters and updating the network configuration data in dependence upon the adjusted network parameters.

8. The method according to claim 7 wherein the adjusted network parameters include element configuration data.

9. The method according to claim 7, wherein the adjusted network parameters include element connection data.

10. The method according to claim 6, further comprising:
accessing a network model of the network;
receiving input data relating to the network;
updating the network model data in dependence upon the received input data;
comparing the network model data with the updated network model data and identifying variations between the network model data and updated network model data.

11. The method according to claim 10, further comprising defining and storing network model data of the network prior to accessing the network model data.

12. The method according to claim 10, further comprising:
identifying the or each altered network parameter responsible at least in part for the variation between the network model data and updated network model data.

13. (canceled)

14. (canceled)

15. A system for configuring a network model of a network which includes a plurality of interconnected network elements, the system comprising:
an element unit operable to store element data; and
an input unit operable to receive selection and connection data;
a configuration unit in communication with the element unit and the input unit, and operable to receive element data, selection data, and connection data, and to configure automatically a network model in dependence upon the received element selection and connection data.
